(19) United States
(12) Patent Application Publication
(10) Pub. No.: US 2013/0218935 A1
(43) Pub. Date: Aug. 22, 2013

(54) INFORMATION PROCESSING APPARATUS, INFORMATION PROCESSING METHOD, AND PROGRAM

(71) Applicant: Sony Corporation, (US)

(72) Inventor: Takatoshi Katou, Kanagawa (JP)

(73) Assignee: Sony Corporation, Tokyo (JP)

(21) Appl. No.: 13/767,341

(22) Filed: Feb. 14, 2013

(30) Foreign Application Priority Data
Feb. 22, 2012 (JP) 2012-035994

(51) Int. Cl. G06F 17/30

(52) U.S. Cl. CPC G06F 17/30115
USPC 707/829

(57) ABSTRACT

An information processing apparatus includes a folder creation unit and a content registration unit. The folder creation unit creates a folder at a predetermined hierarchical level in a predetermined hierarchy of folders. The content registration unit stores content in the folder and associates the content with different content, so that the content is registered for the folder. The folder is created by the folder creation unit. The different content is stored in the same folder as the content.

### BACKGROUND

The present disclosure relates to an information processing apparatus, an information processing method, and a program. More particularly, the present disclosure relates to an information processing apparatus, an information processing method, and a program, which are capable of associating a plurality of pieces of content with each other by a simple operation.

From the past, there has been a content management/delivery system that manages various pieces of content and delivers the content to a user terminal (see, for example, Japanese Patent Application Laid-open No. 2002-041407).

Out of the various pieces of content delivered, a user can search for predetermined content. Such a search for content is performed by using metadata that is associated with the content. With reference to FIG. 1, the association of the metadata with the content will be described.

### (Content Management/Delivery System in Related Art)

FIG. 1 is a diagram showing pieces of content, which are managed by a content management/delivery system in related art.

The assumption is made that the content management/delivery system in related art manages contents 11 to 16. The contents 11 to 16 are each any one of a moving image, a still image, and a text document that are related to an event of an in-house workshop held in 2011. The event of the in-house workshop is classified into an event of a seminar and an event of a lecture. In other words, an event is stratified, so that the event of the in-house workshop is at the highest hierarchical level of the hierarchy, and the events of the seminar and the lecture are at a lower hierarchical level than the in-house workshop.

As shown in FIG. 1, a content administrator needs to manually register metadata for search one by one (hereinafter referred to as “manually register”), and the contents 11 to 16 need to be associated with the metadata.

Specifically, for the content 11, which is a still image, pieces of information related to the content 11 such as “in-house workshop”, “2011”, “seminar”, and “proposal document” are manually input, and an instruction to record the pieces of information, or the like, is given by a manual operation. Thus, the pieces of information are manually registered as the metadata.

For the content 12, which is a text document, pieces of information related to the content 12 such as “in-house workshop”, “2011”, “seminar”, and “specification” are manually input, and an instruction to record the pieces of information, or the like, is given by a manual operation. Thus, the pieces of information are manually registered as the metadata.

For the content 13, which is a moving image, pieces of information related to the content 13 such as “in-house workshop”, “2011”, “seminar”, and “video” are manually input, and an instruction to record the pieces of information, or the like, is given by a manual operation. Thus, the pieces of information are manually registered as the metadata.

For the content 14m which is a still image, pieces of information related to the content 14 such as “in-house workshop”, “2011”, “lecture”, and “written proposal” are manually input, and an instruction to record the pieces of information, or the like, is given by a manual operation. Thus, the pieces of information are manually registered as the metadata.

For the content 15m which is a text document, pieces of information related to the content 15 such as “in-house workshop”, “2011”, “lecture”, and “specification” are manually input, and an instruction to record the pieces of information, or the like, is given by a manual operation. Thus the pieces of information are manually registered as the metadata.

For the content 16, which is a moving image, pieces of information related to the content 16 such as “in-house workshop”, “2011”, “lecture”, and “video” are manually input, and an instruction to record the pieces of information, or the like, is given by a manual operation. Thus, the pieces of information are manually registered as the metadata.

### SUMMARY

As described above, the association of the metadata with the content is performed for each of the pieces of content by a manual operation of the administrator. Therefore, the administrator needs to perform a troublesome operation. Moreover, also in the case where a plurality of pieces of content are related to each other and there is common metadata in the plurality of pieces of content, the administrator needs to register the common metadata for each of the plurality of pieces of content, which takes a long time for the administrator to perform the operation in some cases.

The present disclosure has been made in view of the above circumstances, and it is therefore desirable to associate a plurality of pieces of content with each other by a simple operation.

According to an embodiment of the present disclosure, there is provided an information processing apparatus, including:

a folder creation unit configured to create a folder at a predetermined hierarchical level in a predetermined hierarchy of folders; and

a content registration unit configured to store content in the folder and associate the content with different content, so that the content is registered for the folder, the folder being created by the folder creation unit, the different content being stored in the same folder as the content.

The information processing apparatus may further include:

metadata-for-folders registration unit configured to associate the folder with metadata-for-folders and register, for the folder, the metadata-for-folders, the folder being created by the folder creation unit; and

metadata-for-content registration unit configured to associate the content with the metadata-for-folders and register, for the folder, the metadata-for-folders as metadata-for-content, the metadata-for-folders being associated with and registered for the folder by the metadata-for-folders registration unit, the content being stored in the folder by the content registration unit.

The metadata-for-content registration unit may register, as the metadata-for-content, not only the metadata-for-folders registered for the folder but also different metadata-for-folders registered for a different folder, the folder storing the content, the different folder being created at a higher hierarchical level than the folder.

The information processing apparatus may further include

a content delivery unit configured to release the content to a web portal for content delivery, the content being registered by the content registration unit.

The content delivery unit may release a plurality of pieces of content to the web portal as related content, the plurality of pieces of content being associated with and stored in the same folder.

According to an embodiment of the present disclosure, there are provided an information processing method and a program for the information processing apparatus.

In the information processing method and the program according to the embodiment of the present disclosure, a folder is created at a predetermined hierarchical level in a predetermined hierarchy of folders, content is stored in the created folder, and the content is associated with different content, so that the content is registered for the folder, the different content being stored in the same folder as the content.

As described above, according to the present disclosure, it is possible to associate a plurality of pieces of content with each other by a simple operation.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing pieces of content, which are managed by a content management/delivery system in related art;

FIG. 2 is a diagram showing a configuration example of a content management/delivery system;

FIG. 3 is a block diagram showing a hardware configuration example of a content management/delivery apparatus according to an embodiment of the present disclosure;

FIG. 4 is a block diagram showing a functional configuration example of a CPU (central processing unit);

FIG. 5 is a diagram showing data items that are managed by the content management/delivery apparatus;

FIG. 6 is a flowchart for explaining a flow of a content management/delivery process;

FIG. 7 is a diagram showing an example of a content management screen;

FIG. 8 is a diagram for explaining selection and registration of content to be delivered;

FIG. 9 is a diagram showing an example of an information-to-be-delivered confirmation screen;

FIG. 10 is a diagram showing an example of a top page of a web portal for PC;

FIG. 11 is a diagram showing an example of a detailed page of the web portal for PC;

FIG. 12 is a diagram showing an example of a top page of a web portal for tablet terminal;

FIG. 13 is a diagram for explaining a display example of related content;

FIG. 14 is a diagram showing an example of a top page of a web portal for portable information terminal;

FIG. 15 is a diagram showing an example of a detailed page of the web portal for portable information terminal; and

FIG. 16 is a diagram showing an example of a display page of related content in the web portal for portable information terminal.

### DETAILED DESCRIPTION OF EMBODIMENTS

### [Configuration Example of Content Management/Delivery System]

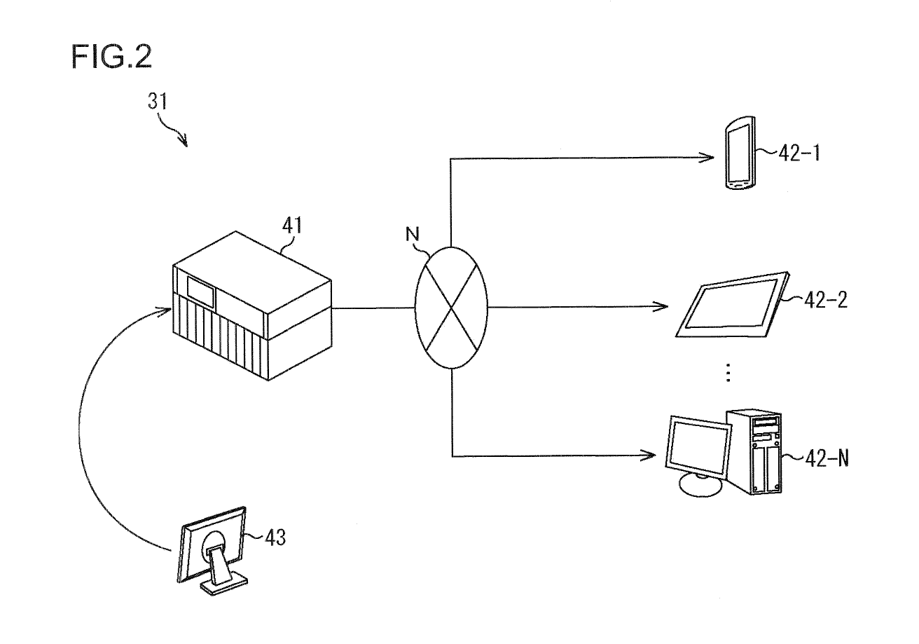

FIG. 2 is a diagram showing a configuration example of a content management/delivery system.

As shown in FIG. 2, a content management/delivery system 31 includes a content management/delivery apparatus 41, user terminals 42-1 to 42-N (N is an arbitrary integer value of 1 or more), and an administrator terminal 43. The content management/delivery apparatus 41 and the user terminals 42-1 to 42-N are connected with each other through a network N such as the Internet. The content management/delivery apparatus 41 and the administrator terminal 43 are connected with each other through a cable, a LAN (Local Area Network), or the like.

The content management/delivery apparatus 41 manages, as data, various pieces of content such as a moving image, a still image, and a text document in accordance with an instruction from the administrator terminal 43. Moreover, the content management/delivery apparatus 41 delivers the various pieces of content to each of the user terminals 42-1 to 42-N via a predetermined web portal in accordance with an instruction from the administrator terminal 43. It should be noted that in the following, a series of processes performed by the content management/delivery apparatus 41 is referred to as a content management/delivery process. The content management/delivery process will be described later in detail.

Each of the user terminals 42-1 to 42-N includes any one of a tablet terminal, a PC (personal computer), a portable information terminal such as a user's smartphone, and the like. Each of the user terminals 42-1 to 42-N can receive, by accessing each web portal, the various pieces of content that are released by the content management/delivery apparatus 41, and reproduce the content. It should be noted that the web portal includes a web portal for portable information terminal, a web portal for tablet terminal, a web portal for PC, and the like. It should be noted that in the following, the user terminals 42-1 to 42-N are collectively referred to as a user terminal 42 if there is no need to distinguish the user terminals 42-1 to 42-N from each other.

The administrator terminal 43 stores the various pieces of content. The administrator terminal 43 receives an operation from the content administrator, and supplies the various pieces of content to the content management/delivery apparatus 41 based on the operation. Moreover, the administrator terminal 43 notifies the content management/delivery apparatus 41 of an instruction to perform the content management/delivery process based on the operation of the content administrator.

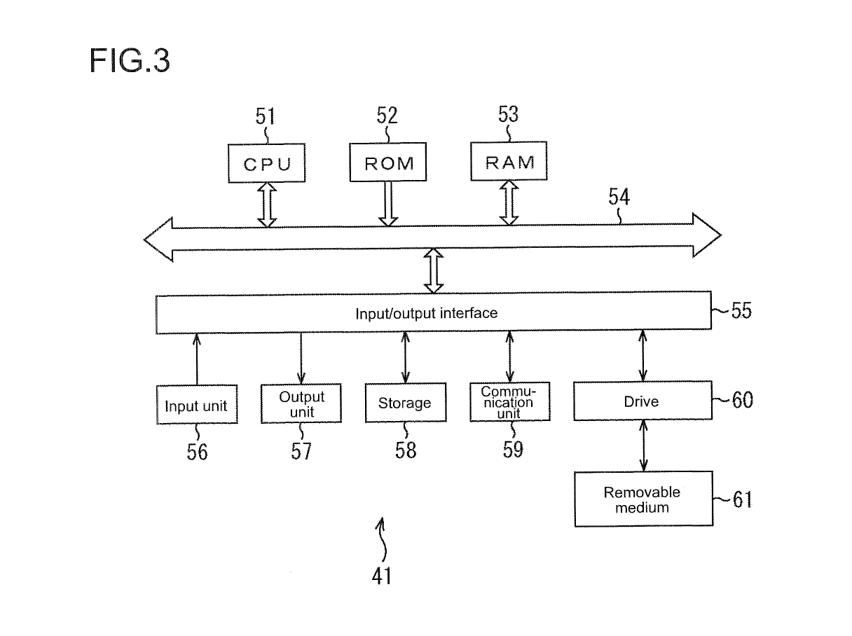

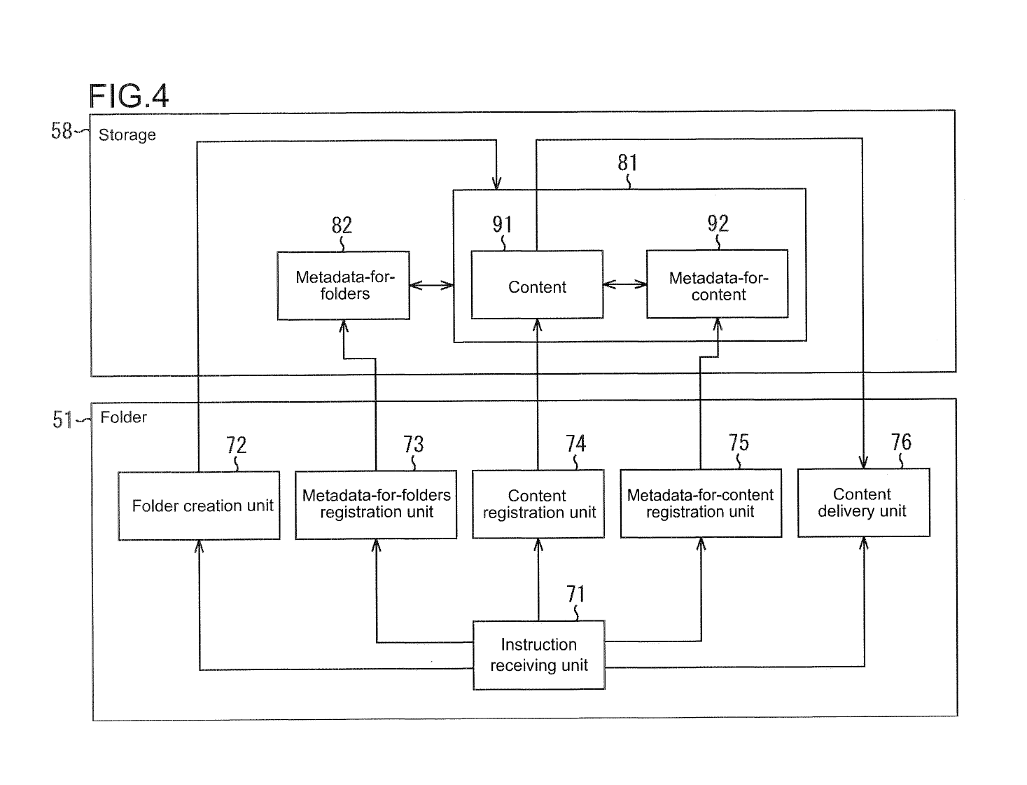

Next, with reference to FIG. 3 and FIG. 4, the content management/delivery apparatus 41 will be described in detail.

### [Configuration Example of Content Management/Delivery Apparatus]

FIG. 3 is a block diagram showing a hardware configuration example of the content management/delivery apparatus 41 to which the present disclosure is applied.

The content management/delivery apparatus 41 includes a CPU (Central Processing Unit) 51, a ROM (Read Only Memory) 52, a RAM (Random Access Memory) 53, a bus 54, an input/output interface 55, an input unit 56, an output unit 57, a storage 58, a communication unit 59, and a drive 60.

The CPU 51 performs various processes in accordance with a program that is stored in the ROM 52. Alternatively, the CPU 51 performs various processes in accordance with a program that is loaded from the storage 58 into the RAM 53. In the RAM 53, data that is necessary for the CPU 51 to perform the various processes, and the like, are stored as appropriate.

The CPU 51, the ROM 52, and the RAM 53 are connected with each other through the bus 54. To the bus 54, also the input/output interface 55 is connected. To the input/output interface 55, the input unit 56, the output unit 57, the storage 58, and the communication unit 59 are connected.

The input unit 56 includes a keyboard, a mouse, a microphone, and the like. The output unit 57 includes a display, a speaker, and the like, and outputs various images.

The storage 58 includes a hard disk, a non-volatile memory, and the like, and stores various pieces of information. For example, content data is stored in a folder and thus stored in the storage 58. Further, metadata is associated with a folder and stored in the storage 58. Hereinafter, such metadata is referred to as metadata-for-folders. In addition, other metadata is associated with content and stored in the storage 58. Hereinafter, such metadata is referred to as metadata-for-content. A relationship between the metadata-for-folders and the metadata-for-content, a method for generating the metadata-for-folders and the metadata-for-content, and the like will be described later in detail.

The communication unit 59 includes, for example, a modem and a terminal adaptor, and controls communication between the user terminal 42 and the communication unit 59 through a network such as the Internet.

To the input/output interface 55, also the drive 60 is connected as necessary, and a removable medium 61 that includes a magnetic disk, an optical disk, a magnetic optical disk, a semiconductor memory, and the like is mounted as necessary. Then, a computer program loaded from the drive 60 or the removable media 61 is installed in the storage 58 as necessary.

### [Functional Configuration Example of CPU]

FIG. 4 is a block diagram showing a functional configuration example for realizing a function for performing the content management/delivery process, out of functions of the CPU 51 in the content management/delivery apparatus 41 shown in FIG. 3.

The CPU 51 includes an instruction receiving unit 71, a folder creation unit 72, a metadata-for-folders registration unit 73, a content registration unit 74, a metadata-for-content registration unit 75, and a content delivery unit 76.

The instruction receiving unit 71 receives various instructions from the administrator terminal 43, and notifies a corresponding unit being an instruction target, out of the folder creation unit 72, the metadata-for-folders registration unit 73, the content registration unit 74, the metadata-for-content registration unit 75, and the content delivery unit 76, of the instructions.

The folder creation unit 72 creates a folder 81 in the storage 58 based on an instruction from the instruction receiving unit 71. It should be noted that, as will be described later in detail, the folder 81 means a classification unit for managing content, and can be created so as to establish a hierarchy. Specifically, the folder creation unit 72 creates a folder at a predetermined hierarchical level of the hierarchy. For example, the folder 81 is created at the first hierarchical level for each of predetermined events such as a lecture and a seminar. Also, the folder 81 is created at a lower hierarchical level than the first hierarchical level of the lecture for each of various classification items related to the lecture, and created at a lower hierarchical level than the first hierarchical level of the seminar for each of various classification items related to the seminar.

The metadata-for-folders registration unit 73 creates metadata-for-folders 82 for each folder 81, and associates the metadata-for-folders 82 with the folder 81 to store the metadata-for-folders 82 in the storage 58 (hereinafter referred to as “register” as appropriate), based on an instruction from the instruction receiving unit 71. For example, for a folder at the first hierarchical level related to a predetermined event, the metadata-for-folders 82 that includes pieces of information on an event name of the predetermined event, a time and date for the predetermined event, a place for the predetermined event, and the like, is created to be registered.

The content registration unit 74 stores, in the folder 81 that is created by the folder creation unit 72, predetermined content 91, out of various pieces of content that are stored in the administrator terminal 43, thereby associating a plurality of pieces of content 91 that are stored in the same folder 81 with each other, based on an instruction from the instruction receiving unit 71. Here, since the folder 81 is created at a predetermined hierarchical level in the hierarchy, one or more folders may exist at a lower hierarchical level than the folder 81. In such a case, also the content 91 stored not in the folder 81 directly but in a folder that is created at a lower hierarchical level than the folder 81 can be regarded to be stored in the folder 81. In other words, also content stored in a folder at a lower hierarchical level than the hierarchical level of the folder 81 is associated with other content as content that is stored in the folder 81. It should be noted that in the following, “the content 91 is stored in the folder 81” is referred to as “register” as appropriate.

In the case where the content registration unit 74 registers a predetermined content 91 in a predetermined folder 81, the metadata-for-content registration unit 75 creates metadata-for-content 92 for the predetermined content 91 based on the metadata-for-folders 82 that is registered for the predetermined folder 81. Then the metadata-for-content registration unit 75 associates the metadata-for-content 92 with the predetermined content 91 to store the metadata-for-content 92 in the predetermined folder 81 (hereinafter referred to as register as necessary).

Here, the metadata-for-content 92 only has to be created based on the metadata-for-folders 82 that is associated with the folder 81 to which the metadata-for-content 92 is registered, and the metadata-for-content 92 is not particularly limited. For example, the metadata-for-content 92 may be created so as to include all or part of the metadata-for-folders 82. Alternatively, new metadata that is different from the metadata-for-folders 82 may be created. Moreover, the metadata-for-content 92 may be created so as to include not only information related to the metadata-for-folders 82 but also information other than the metadata-for-folders 82, e.g., information manually input by the administrator.

Moreover, part or all of the metadata-for-content 92 is used as a search tag for the content 91 that is associated with the metadata-for-content 92.

The content delivery unit 76 selects the content 91 to be delivered and sets delivery information, based on an instruction from the instruction receiving unit 71. After the delivery information is set, the content delivery unit 76 releases the content 91 to a web portal for delivery to the user terminal 42. Here, the delivery information represents information related to a visitor capable of viewing and listening to the content 91, a web portal to which the content 91 is delivered, a release period of the content 91, and the like.

### [Data Items Managed by Content Management/Delivery Apparatus]

Next, data items that are managed by the content management/delivery apparatus 41 will be described.

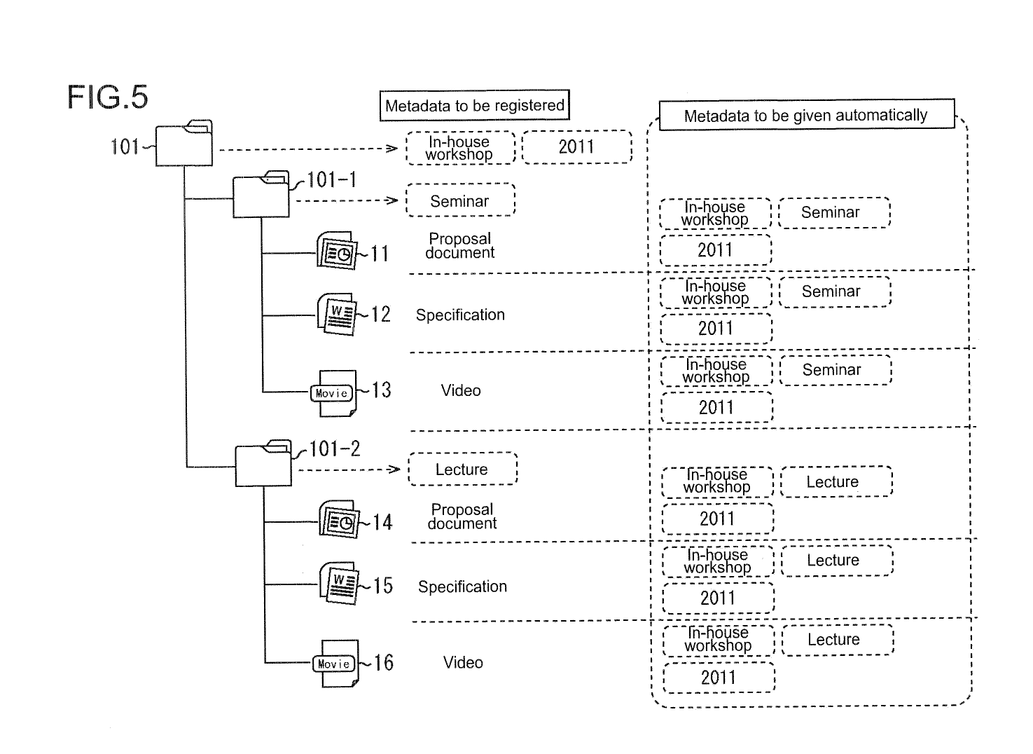

FIG. 5 is a diagram showing data items that are managed by the content management/delivery apparatus 41 in the content management/delivery system 31.

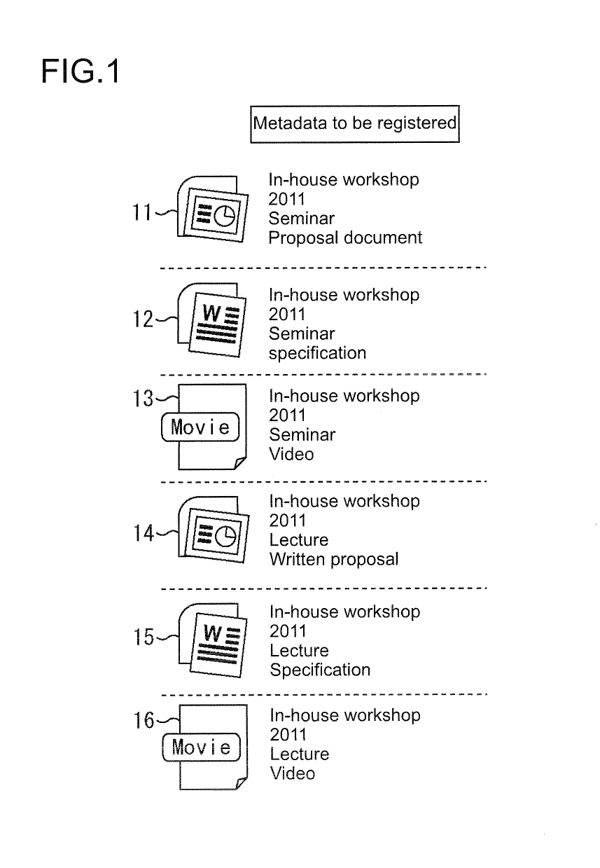

In order to easily compare with the pieces of content that are managed by the content management/delivery system in related art (see FIG. 1), in this embodiment, the assumption is made that the contents 11 to 16, which are the same content as the pieces of content that are managed by the content management/delivery system in related art, are managed by the content management/delivery apparatus 41.

Specifically, the contents 11 to 16 are each any one of a moving image, a still image, and a text document that are are related to an event of an in-house workshop held in 2011. The event of the in-house workshop is classified into an event of a seminar and an event of a lecture. In other words, an event is stratified, so that the event of the in-house workshop is at the highest hierarchical level of the hierarchy, and the events of the seminar and the lecture are at a lower hierarchical level than the in-house workshop.

Since the event is stratified, also a folder in which the contents 11 to 16 are stored is stratified. Specifically, since the event at the highest hierarchical level of the hierarchy is the in-house workshop, a folder 101 that corresponds to the in-house workshop is created in the storage 58. Further, since the events of the seminar and the lecture are at a lower hierarchical level than the in-house workshop, a folder 101-1 that corresponds to the seminar and a folder 101-2 that corresponds to the lecture are created at a lower hierarchical level than the folder 101 in the storage 58.

Specifically, the assumption is made that the folder 101 that corresponds to the in-house workshop is created at the highest hierarchical level and “in-house workshop” and “2011” are registered, as metadata-for-folders, by the administrator in advance. At a lower hierarchical level than the hierarchical level of the folder 101, the folder 101-1 that corresponds to the seminar and the folder 101-2 that corresponds to the lecture are created, which are at the same hierarchical level. The assumption is made that “seminar” is registered, for the folder 101-1, as metadata-for-folders by the administrator in advance, and “lecture” is registered, for the folder 101-2, as metadata-for-folders by the administrator in advance.

The contents 11 to 13 managed by the content management/delivery apparatus 41 are stored, by the administrator, in the folder 101-1 that corresponds to the seminar, out of folders at a lower hierarchical level than the folder 101 that corresponds to the in-house workshop, because the contents 11 to 13 are related to the seminar of the in-house workshop. In this way, the contents 11 to 13 stored in the same folder 101-1 are automatically associated with each other by the content management/delivery apparatus 41. Specifically, for the contents 11 to 13, pieces of metadata-for-folders for the folder 101 and the folder 101-1 that establish a hierarchy, i.e., “in-house workshop”, “2011”, and “seminar”, are automatically given, by the content management/delivery apparatus 41, to be registered as metadata-for-content (hereinafter referred to as “automatically registered”).

Similarly, The contents 14 to 16 managed by the content management/delivery apparatus 41 are stored, by the administrator, in the folder 101-2 that corresponds to the lecture, out of folders at a lower hierarchical level than the folder 101 that corresponds to the in-house workshop, because the contents 14 to 16 are related to the lecture of the in-house workshop. In this way, the contents 14 to 16 stored in the same folder 101-2 are automatically associated with each other by the content management/delivery apparatus 41. Specifically, for the contents 14 to 16, pieces of metadata-for-folders for the folder 101 and the folder 101-2 that establish a hierarchy, i.e., “in-house workshop”, “2011”, and “lecture”, are automatically registered as metadata-for-content by the content management/delivery apparatus 41.

For the contents 11 to 16 for which such metadata-for-content is registered, the content administrator can additionally register metadata-for-content by a manual input.

In FIG. 5, for the content 11, which represents a proposal document for the seminar and for which pieces of metadata-for-content, i.e., “in-house workshop”, “2011”, and “seminar” are automatically registered, metadata-for-content of “proposal document” is manually registered by the administrator.

Similarly, for the content 12, which represents a specification for the seminar and for which pieces of metadata-for-content, i.e., “in-house workshop”, “2011”, and “seminar” are automatically registered, metadata-for-content of “specification” is manually registered by the administrator.

Similarly, for the content 13, which represents video of the seminar and for which pieces of metadata-for-content of “in-house workshop”, “2011”, and “seminar” are automatically registered, metadata-for-content of “video” is manually registered by the administrator.

In addition, for the content 14, which represents a proposal document of the lecture and for which pieces of metadata-for-content i.e., “in-house workshop”, “2011”, and “lecture” are automatically registered, metadata-for-content of “proposal document” is manually registered by the administrator.

Similarly, for the content 15, which represents a specification for the lecture and for which pieces of metadata-for-content, i.e., “in-house workshop”, “2011”, and “lecture” are automatically registered, metadata-for-content of “specification” is manually registered by the administrator.

Similarly, for the content 16, which represents video of the lecture and for which pieces of metadata-for-content, i.e., “in-house workshop”, “2011”, and “lecture” are automatically registered, metadata-for-content of “video” is manually registered by the administrator.

As described above, in the content management/delivery apparatus 41, since the contents 11 to 13 are automatically associated with each other when the content 11 to 13 are stored in the folder 101-1 at a lower hierarchical level than the folder 101 that establish a hierarchy, metadata-for-content is automatically given to be registered. Similarly, since the contents 14 to 16 are automatically associated with each other when the content 14 to 16 are stored in the folder 101-2 at a lower hierarchical level than the folder 101 that establish a hierarchy, metadata-for-content is automatically given to be registered.

As described above, for content stored in a folder at a low hierarchical level, metadata can be given at one time to be registered for each folder by the administrator.

As described above, according to the content management/delivery apparatus 41, it is possible to associate a plurality of pieces of content with each other by a simple operation.

[Content Management/Delivery Process]

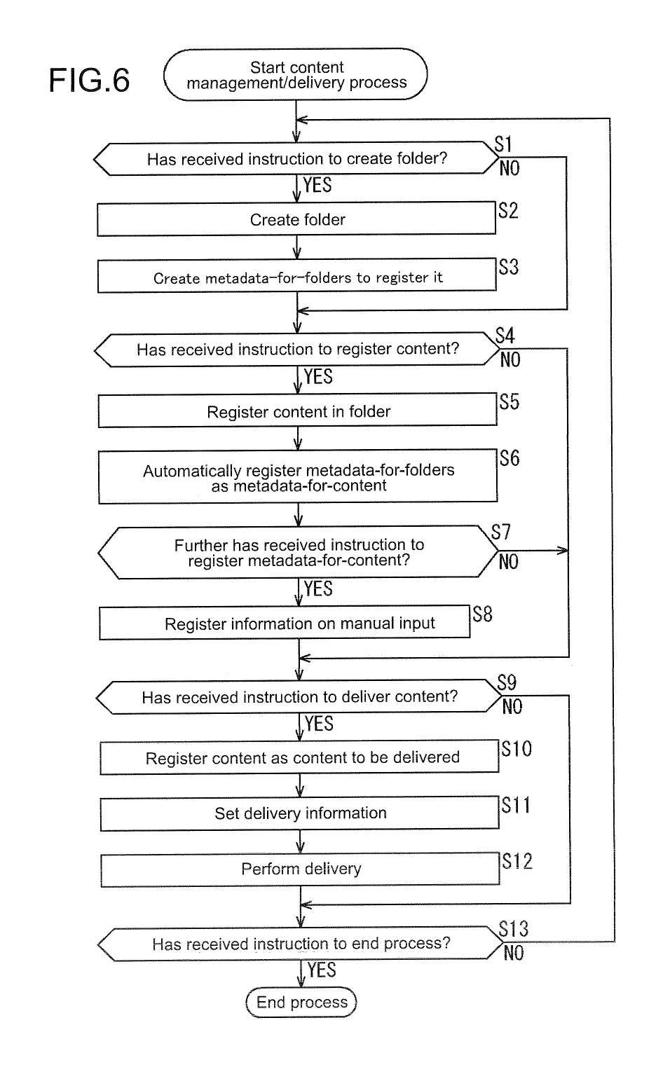

FIG. 6 is a flowchart for explaining a flow of the content management/delivery process.

In Step S1, the instruction receiving unit 71 determines whether or not the content management/delivery apparatus 41 has received an instruction to create a folder from the administrator terminal 43.

In the case where the content management/delivery apparatus 41 has not received the instruction to create a folder, the process proceeds to Step S4 because it is determined No in Step S1. It should be noted that processes of Step S4 and subsequent Steps will be described later.

In the case where the content management/delivery apparatus 41 has received the instruction to create a folder, the process proceeds to Step S2 because it is determined Yes in Step S1.

In Step 2, the folder creation unit 72 creates a folder based on an instruction from the instruction receiving unit 71. It should be noted that the number of folders to be created is not limited, and the folder is created so as to establish a hierarchy for each classification unit of content.

In Step 3, the metadata-for-folders registration unit 73 creates metadata-for-folders and associates the metadata-for-folders with a folder to register the metadata-for-folders, based on an instruction from the instruction receiving unit 71.

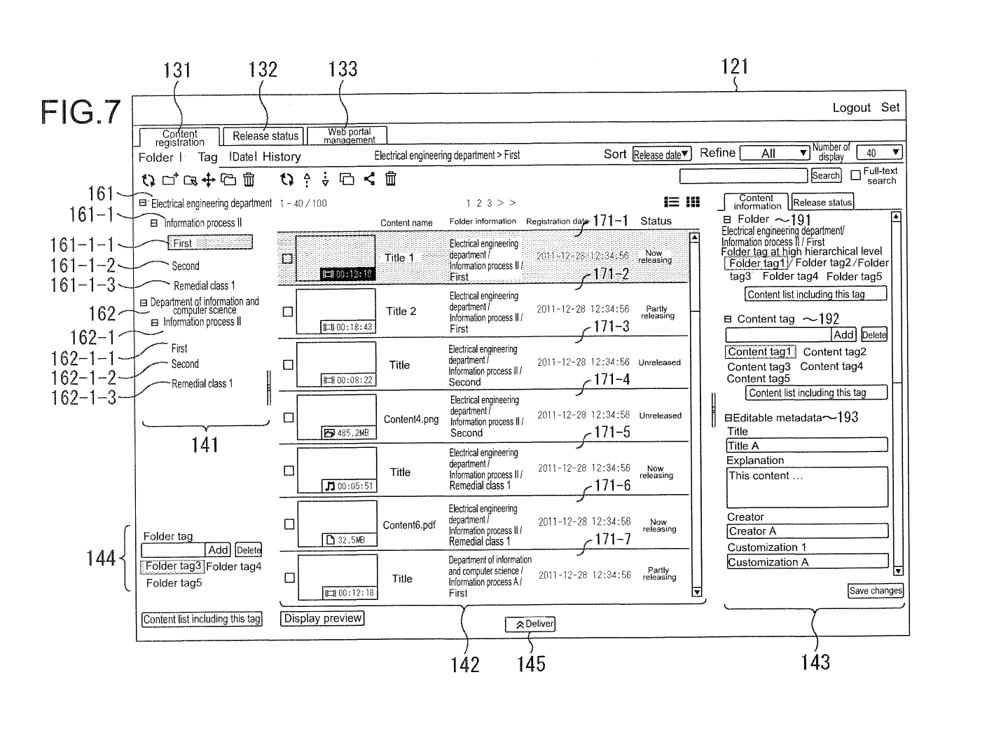

Specifically, as shown in a content management screen of FIG. 7, pieces of metadata-for-folders are registered for a plurality of folders created, for example.

### [Content Management Screen]

Now, the content management screen will be described. FIG. 7 is a diagram showing an example of the content management screen.

A content management screen 121 shown in FIG. 7 includes a content registration screen 131, a release-status display screen 132, and a web portal management screen 133.

The content registration screen 131 is used from when metadata-for-content is registered for content to when content is selected for delivery and then registered.

The release-status display screen 132 displays a status of content selected for delivery before being released to a web portal.

The web portal management screen 133 is used in the case where content delivered to a web portal is managed. For example, via the web portal management screen 133, the administrator can change the release period of the content and confirm a comment for the content, which is received from the user terminal 42.

It should be noted that in this specification, only the content registration screen 131 shown in FIG. 7 will be described. On the content registration screen 131, a hierarchy display area 141, a content display area 142, a metadata edition area 143, a tag-for-individual-folders edition area 144, and a delivery cart area 145 are disposed.

In the process in Step S2, a plurality of folders displayed in the hierarchy display area 141 are created. In the process in Step S3, pieces of metadata-for-folders are registered for the plurality of folders.

Specifically, in the hierarchy display area 141, a folder 161 and a folder 162 are created as a folder at the first hierarchical level that is the highest hierarchical level.

For the folder 161 at the first hierarchical level, “electrical engineering department” is registered as metadata-for-folders. Moreover, at a lower hierarchical level than the folder 161 that is at the first hierarchical level, a folder 161-1 at the second hierarchical level is created, and “information process II” is registered for the folder 161-1 as metadata-for-folders. Moreover, at a lower hierarchical level than the folder 161-1 that is at the second hierarchical level, folders 161-1-1 to 161-1-3 at the third hierarchical level are created, and “first”, “second”, and “remedial class 1” are registered for the respective folders as metadata-for-folders.

For the folder 162 at the first hierarchical level, “department of information and computer science” are registered as metadata-for-folders. Moreover, at a lower hierarchical level than the folder 162 at the first hierarchical level, a folder 162-1 at the second hierarchical level is created, and “information process II” is registered for the folder 162-1 as metadata-for-folders. Moreover, at a lower hierarchical level than the folder 162-1 that is at the second hierarchical level, folders 162-1-1 to 162-1-3 at the third hierarchical level are created, and “first”, “second”, and “remedial class 1” are registered for the respective folders as metadata-for-folders.

It should be noted that in the tag-for-individual-folders edition area 144, the administrator can individually edit metadata-for-folders that is a tag for a selected folder (folder 161-1-1 in the example of FIG. 7). In FIG. 7, “folder tag 3 . . . folder tag 5” are registered as metadata-for-folders for the folder 161-1-1. Based on the input operation manually performed by the administrator, metadata-for-folders is registered in the process in Step S3.

Turning back to FIG. 6, in Step S4, the instruction receiving unit 71 determines whether or not the content management/delivery apparatus 41 has received an instruction to register content from the administrator terminal 43.

In the case where the content management/delivery apparatus 41 has not received the instruction to register content, the process proceeds to Step S9 because it is determined No in Step S4. It should be noted that processes of Step S9 and subsequent Steps will be described later.

In the case where the content management/delivery apparatus 41 has received the instruction to register content, the process proceeds to Step S5 because it is determined Yes in Step S4.

In Step S5, the content registration unit 74 registers content in a folder based on an instruction from the instruction receiving unit 71. Specifically, the content registration unit 74 registers, for a folder that is created by the folder creation unit 72 in the process in Step S2, predetermined content, out of various pieces of content that are stored in the administrator terminal 43. It should be noted that the number of content to be registered is not limited.

Specifically, for the folder 161-1-1 shown in FIG. 7, contents 171-1 to 171-N (N is an integer value of 1 or more) are registered, for example. It should be noted that in the content display area 142, pieces of information that represent the contents 171-1 to 171-7 are displayed. Hereinafter, the contents 171-1 to 171-N are collectively referred to as a content 171 if there is no need to distinguish the contents 171-1 to 171-N from each other.

Turning back to FIG. 6, in Step S6, the metadata-for-content registration unit 75 automatically registers, for content, metadata-for-folders as metadata-for-content. Specifically, the metadata-for-content registration unit 75 automatically registers, as metadata-for-content, metadata-for-folders that is registered in a folder in the process in Step S3 for predetermined content that is registered in the folder in the process in Step S5.

Specifically, for the content 171 that is registered in the folder 161-1-1 shown in FIG. 7, for example, metadata-for-folders associated with the folder 161-1-1 is automatically registered as metadata-for-content, and information on the automatic registration is displayed as folder information included in information that represents the content 171. As described above, metadata-for-folders to be automatically registered includes metadata-for-folders associated with the folders 161 and 161-1 that are at a higher hierarchical level than the folder 161-1-1.

As shown in FIG. 7, information that represents the content 171 includes preview display of the content 171, a content name, folder information, a registration date, and a status. Here, the preview display includes not only display of a moving image, a still image, and a text document, but also an output of music or the like. As will be described later, as the content name, metadata-for-content, which is information manually input by the administrator for the content 171 in the process in Step S8, is used. As the folder information, metadata-for-folders, which is associated with the folder 161-1-1 in which the content 171 is registered and then automatically registered for the content 171 as metadata-for-content, is displayed. Moreover, the registration date indicates the time and date when the content 171 is registered in the folder 161-1-1. The status indicates a release status of the content 171 to the user terminal 42.

Specifically, at the first line of the content display area 142 shown in FIG. 7, as information representing the content 171-1 that is a moving image, preview display of the moving image is displayed, as the content name, “title 1” is displayed, as the folder information, “electrical engineering department/information process II/first” is displayed, as the registration date, “2011-12-28 12;34;45” is displayed, and as the status, “Now releasing” is displayed. Similarly, also at the second to seventh lines, pieces of information that represent the contents 171-2 to 171-7 are displayed, respectively.

Turning back to FIG. 6, in Step S7, the instruction receiving unit 71 further determines whether the content management/delivery apparatus 41 has received an instruction to register, for predetermined content, metadata-for-content.

In the case where the content management/delivery apparatus 41 has not received the instruction to register metadata-for-content, the process proceeds to Step S9 because it is determined No in Step S7.

In the case where the content management/delivery apparatus 41 has received the instruction to register metadata-for-content, the process proceeds to Step S8 because it is determined Yes in Step S7.

In Step S8, the metadata-for-content registration unit 75 registers, as metadata-for-content, information on an input operation, which is manually performed by the administrator based on an instruction from the instruction receiving unit 71.

Specifically, in FIG. 7, the assumption is made that the content 171-1 is in selected status (highlight display), and an instruction to register metadata-for-content associated with the content 171-1 has been received, for example. In this case, in the metadata edition area 143, the administrator can manually input, for the content 171-1, metadata-for-content.

Specifically, the metadata edition area 143 includes a folder display area 191, a content tag edition area 192, and editable metadata area 193.

In the folder display area 191, pieces of metadata-for-folders for the folder 161-1-1 in which the content 171-1 is registered and for the folders 161-1 and 161 at a higher hierarchical level than the folder 161-1-1, are displayed in order from a high hierarchical level to a low hierarchical level. In the case of FIG. 7, “electrical engineering department/information process II/first” are displayed.

In the folder display area 191, tags for folders at a higher hierarchical level than the folder 161-1-1 in which the content 171-1 is registered, i.e., one or more tags registered as a tag for folders in the tag-for-individual-folders edition area 144 are displayed as a folder tag at a high hierarchical level. In the case of FIG. 7, although “folder tag 1/folder tag2 . . . folder tag 5” are displayed, in the case where, for example, “electrical engineering department” is registered as “folder tag 1”, “information process II” is registered as “folder tag 2”, and “first” is registered as “folder tag 3”, actually, “electrical engineering department/information process II/first” are displayed.

It should be noted that if an area displayed as “content list including this tag” is selected, a list of pieces of content with which a tag for folders displayed in the highlight color at the time of the selection is associated as metadata-for-content is displayed. Here, a folder is created so as to have a hierarchy, and content registered in a folder at a low hierarchical level is associated with, as metadata-for-content, not only a tag for folders for the folder but also a tag for folders for a folder at a high hierarchical level. Therefore, displayed is a list of content registered in any one of a folder associated with a tag for folders displayed in the highlight color at the time of the selection and a folder at a lower hierarchical level than that.

In the content tag edition area 192, the administrator can create new metadata-for-content to be a tag for the content 171-1 and additionally register the new metadata-for-content. The type or number of the metadata-for-content that can be additionally registered is not particularly limited, as long as the metadata-for-content is information by which the user can search for the content 171-1. In the case of FIG. 7, “content tag 1 . . . content tag 5” are registered as metadata-for-content to be a tag based on an input operation manually performed by the administrator.

It should be noted that if the area displayed as “content list including this tag” is selected, a list of content associated with metadata-for-content to be a tag displayed in the highlight color at the time of the selection as metadata-for-content is displayed.

In the editable metadata area 193, the administrator can edit metadata-for-content for the content 171-1. Specifically, the administrator can freely edit a title, explanation, a creator, and the like of metadata-for-content associated with the content 171-1. Moreover, the administrator can create new metadata-for-content as customization. Based on these input operations manually performed by the administrator, metadata-for-content is registered in the process in Step S8.

Turning back to FIG. 6, in Step S9, the instruction receiving unit 71 determines whether or not the content management/delivery apparatus 41 has received an instruction to deliver content from the administrator terminal 43.

In the case where the content management/delivery apparatus 41 has not received the instruction to deliver content, the process proceeds to Step S13 because it is determined No in Step S9.

In the case where the content management/delivery apparatus 41 has received the instruction to deliver content, the process proceeds to Step S10 because it is determined Yes in Step S9.

In Step S10, the content delivery unit 76 registers content as content to be delivered.

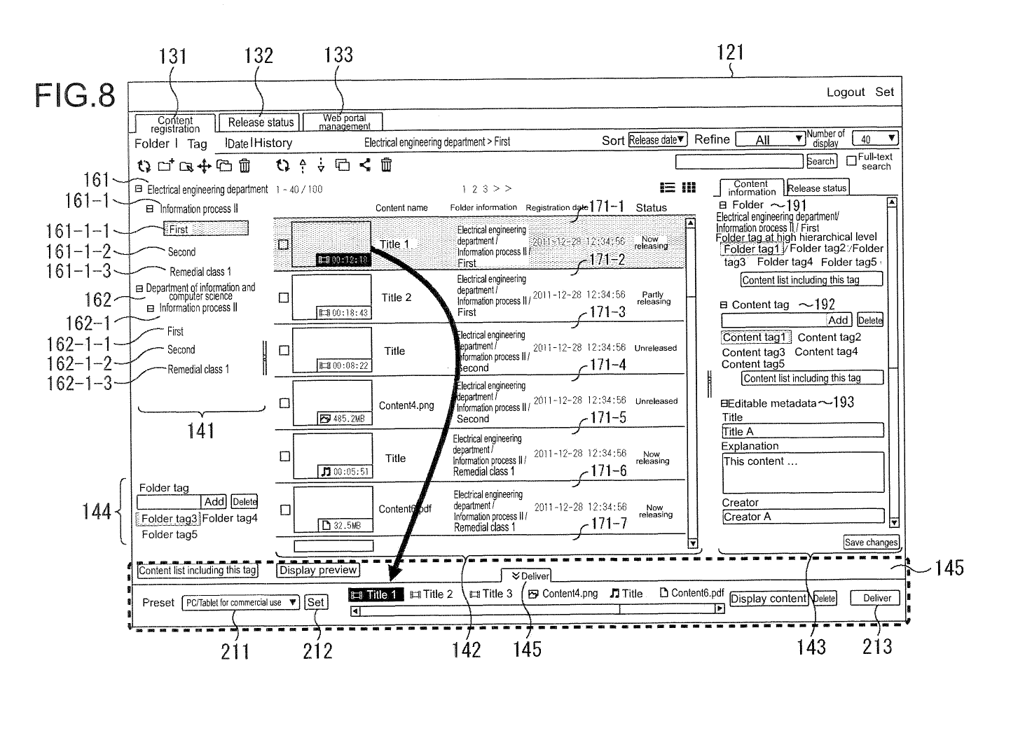

Specifically, in the delivery cart area 145, content to be delivered is selected to be registered. In the example shown in FIG. 7, the delivery cart area 145 is not displayed. However, if a tab described as “deliver” is selected, the delivery cart area 145 is displayed as shown in FIG. 8.

### [Selection of Content to be Delivered]

FIG. 8 is a diagram for explaining selection and registration of content to be delivered.

At a lower portion of the content registration screen 131 shown in FIG. 8, the delivery cart area 145 is displayed. The administrator selects the content 171 to be delivered in the content display area 142, and performs an operation to move the content 171 to the delivery cart area 145. Thus, the content delivery unit 76 registers the selected content 171 as the content 171 to be delivered.

First, the administrator selects a delivery destination for the content 171 to be delivered (i.e., web portal to which the content 171 is released) in the delivery cart area 145. Specifically, the administrator selects an inverted triangular mark in a delivery destination preset selection field 211 placed in the left side of the delivery cart area 145, and thus candidates of the delivery destination that can be selected as a delivery target are displayed (not shown). The administrator selects a delivery destination out of the displayed candidates of the delivery destination. It should be noted that in the delivery destination preset selection field 211, although a candidate of the delivery destination that is set in advance (i.e., preset) is displayed, in the case where the administrator wants to set another delivery destination, the administrator can set a new delivery destination by selecting a setting button 212. In the case of FIG. 8, as a web portal being a delivery target, “PC/Tablet for commercial use” is selected.

Next, the administrator selects the content 171 that is to be released to a web portal being the selected delivery destination and to be delivered. Specifically, the administrator operates a mouse to perform a so-called “drag and drop” operation, i.e., positioning a mouse pointer over information that represents the selected content 171, clicking either the left or right mouse button, moving the mouse pointer to the delivery cart area 145 while holding the mouse button down (dragging), and releasing the mouse button in the delivery cart area 145. Accordingly, the administrator can set the selected content 171 as the content 171 to be delivered.

After selecting the content 171 to be delivered, the administrator clicks a delivery button 213 that is placed in the right side of the delivery cart area 145. Accordingly, the content delivery unit 76 registers the selected content 171 as the content 171 to be delivered.

Turning back to FIG. 6, in Step S11, the content delivery unit 76 sets the delivery information of content.

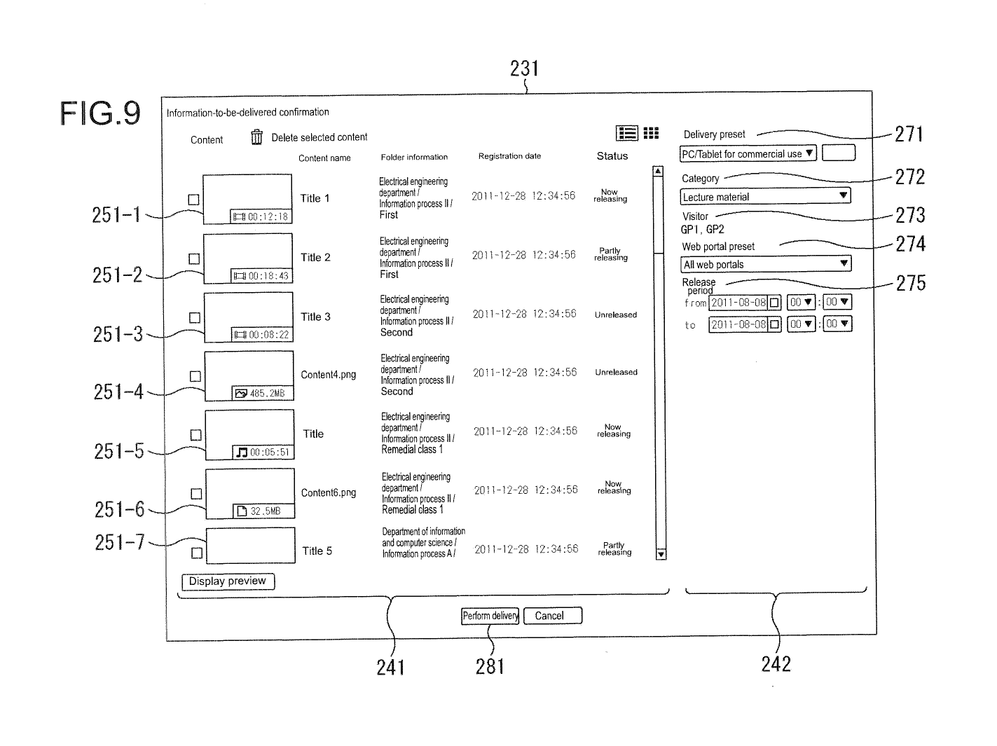

Specifically, the content 171 is registered as the content 171 to be delivered in the process in Step S10, and then the administrator can confirm the registered content 171 to be delivered and set the delivery information in an information-to-be-delivered confirmation screen shown in FIG. 9. It should be noted that the information-to-be-delivered confirmation screen shown in FIG. 9 is displayed if the administrator clicks the delivery button 213. If the administrator sets the delivery information on the registered content 171 to be delivered in the information-to-be-delivered confirmation screen, the content delivery unit 76 sets the delivery information of content.

### [Information-to-be-Delivered Confirmation]

FIG. 9 is a diagram showing an example of an information-to-be-delivered confirmation screen.

In an information-to-be-delivered confirmation screen 231 shown in FIG. 9, a content-to-be-delivered display area 241 and a delivery information setting area 242 are disposed.

As shown in FIG. 9, in the content-to-be-delivered display area 241, out of pieces of information that represent contents 251-1 to 251-N (N is an arbitrary integer value of 1 or more) to be delivered that are registered by the administrator, pieces of information that represent the contents 251-1 to 251-7 are displayed. It should be noted that in the following, the contents 251-1 to 251-N are collectively referred to as a content 251 if there is no need to distinguish the contents 251-1 to 251-N from each other.

In the delivery information setting area 242, delivery information on the content 251 that is displayed in the content-to-be-delivered display area 241 is set. The delivery information setting area 242 includes a delivery preset setting area 271, a category setting area 272, a visitor setting area 273, a web portal preset area 274, and a release period setting area 275.

In the delivery preset setting area 271, a delivery destination selected in the delivery destination preset selection field 211 that is placed in the left side of the delivery cart area 145 shown in FIG. 8 is displayed. It should be noted that the administrator can re-select a delivery destination in the delivery preset setting area 271, and set a new delivery destination, similarly as in the case of FIG. 8.

In the category setting area 272, a category of the content 251 in a web portal that is a delivery destination is set. In the example of FIG. 9, as the category of the content 251 in a web portal that is a delivery destination, “lecture material” is set.

In the visitor setting area 273, a visitor who is capable of browsing the content 251 in the web portal that is a delivery destination is set. Examples of the visitor include a group of predetermined visitors. In the example of FIG. 9, as the group of visitors who is capable of browsing the content 251, “GP1, GP2” are set.

In the web portal preset area 274, a web portal that is a delivery destination to which the content 251 is released is set. Examples of the web portal that is a delivery destination include “only web portal for PC”, “web portal for PC and web portal for tablet terminal”, and “all web portals.” In the example of FIG. 9, as the web portal that is a delivery destination, “all web portals” is set.

In the release period setting area 275, a release release period setting area 275, the administrator sets the commencement and termination of the release period of the content 251. As described above, if the administrator sets delivery information of the registered content 171 to be delivered in the information-to-be-delivered confirmation screen 231, the content delivery unit 76 sets the delivery information of the content 171.

Turning back to FIG. 6, in Step S12, the content delivery unit 76 performs delivery of content. Accordingly, the content is released to a web portal for the user terminal 42.

Specifically, in the case where all of the delivery information described above is set in the information-to-be-delivered confirmation screen 231, if the administrator clicks a delivery performing button 281, the content delivery unit 76 performs delivery of content. Accordingly, the content 251 displayed in the content-to-be-delivered display area 241 is displayed on a web portal for the set user terminal 42 based on the delivery information set in the delivery information setting area 242.

Turning back to FIG. 6, in Steps S13, the instruction receiving unit 71 determines whether or not the content management/delivery apparatus 41 has received an instruction to end a process from the administrator terminal 43.

In the case where the content management/delivery apparatus 41 has not received the instruction to end a process, the process returns to Step S1 because it is determined No in Step S13. Then, processes of Step S1 and subsequent Steps are repeated. In other words, until the content management/delivery apparatus 41 receives the instruction to end a process, the loop process of Step S1 to Step S13 is repeated.

Thereafter, in the case where the content management/delivery apparatus 41 has received the instruction to end a process, the content management/delivery process is ended because it is determined Yes in Step S13.

It should be noted that the content management/delivery process is performed by one operation and one UI (user interface). Specifically, the content management/delivery process is a process in which processes related to content management (Step S1 to S8) and processes related to content delivery (Step S9 to Step S12) are combined. Therefore, it is possible to perform content management and content delivery by one operation and one UI.

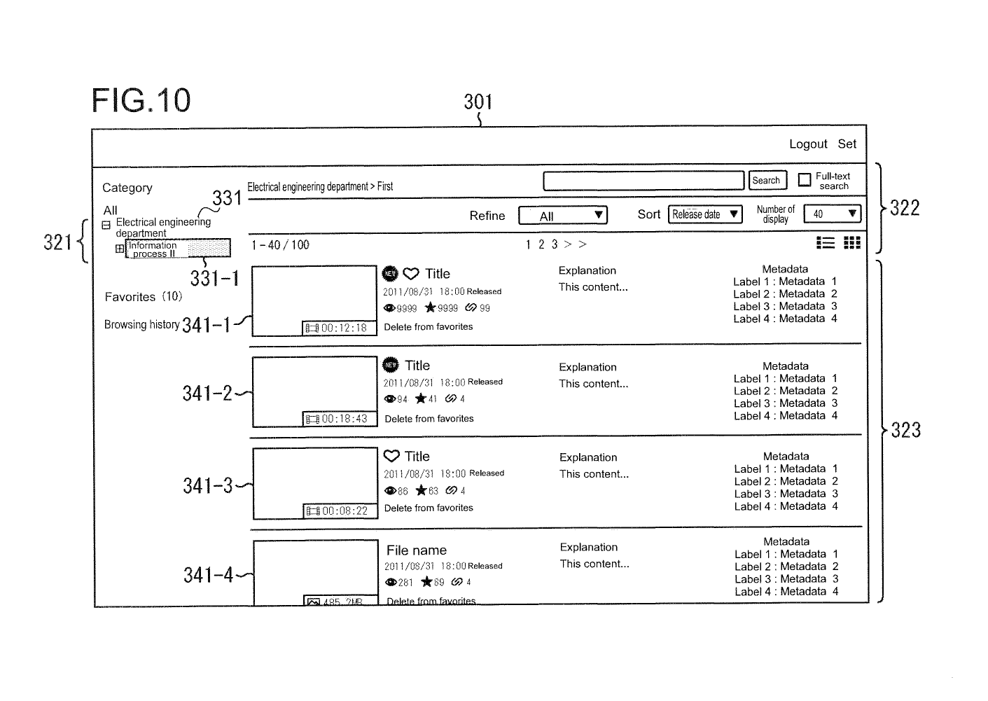

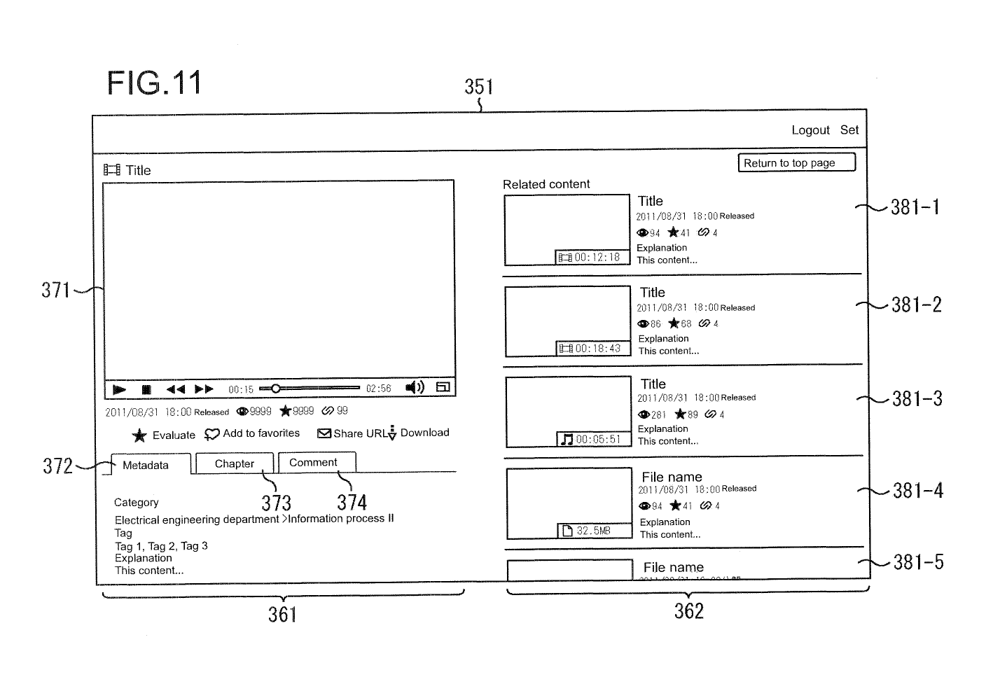

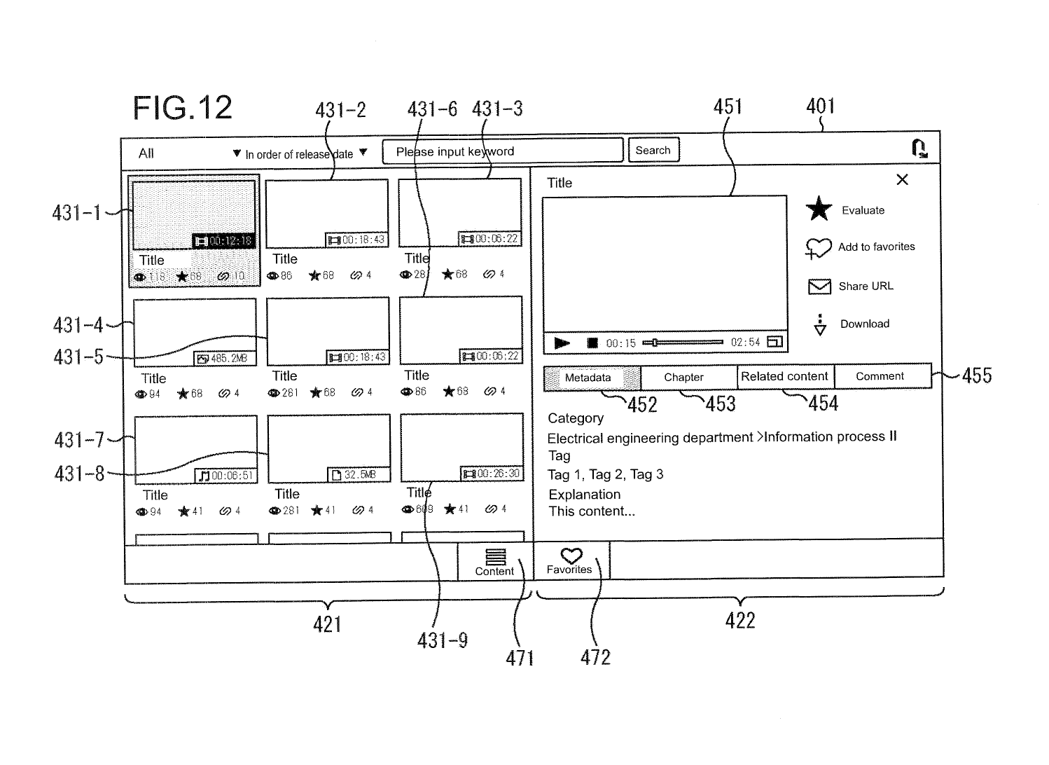

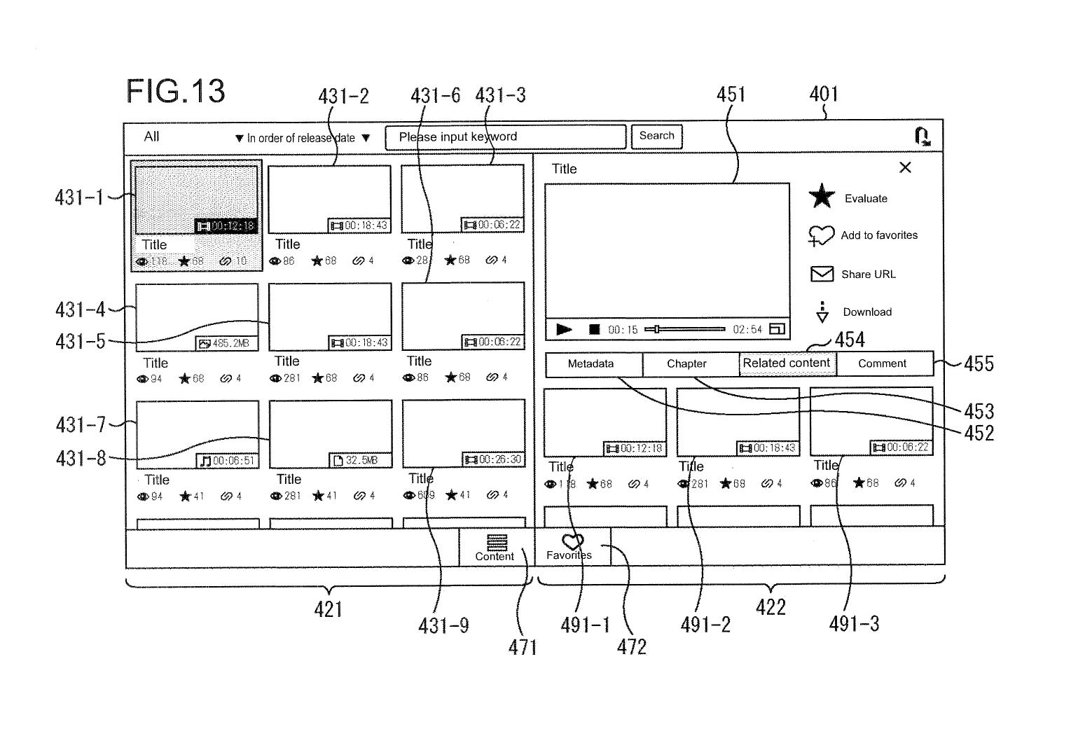

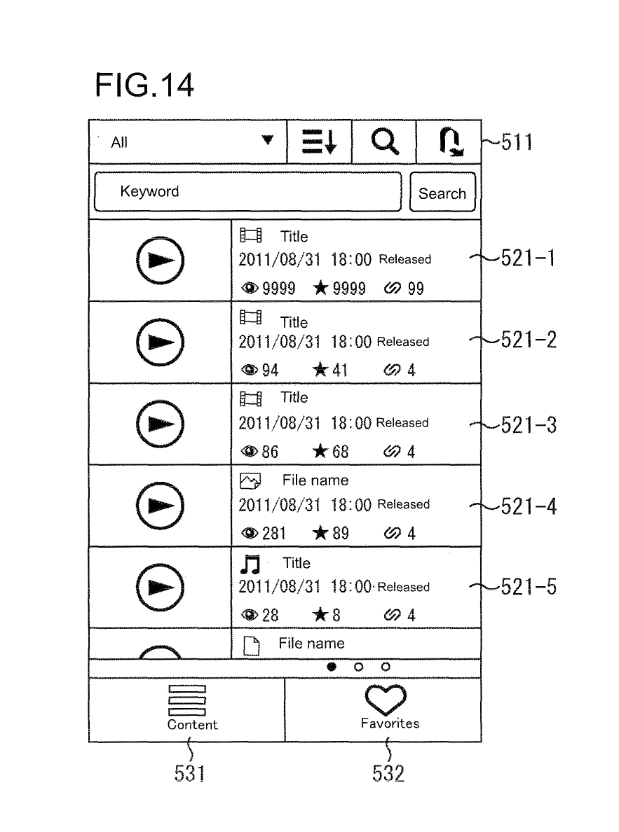

In this way, content is released to a web portal for the user terminal 42. The content is released so that the hierarchy of folders in the storage 58 is maintained. Therefore, the user can view and listen to the content while maintaining the hierarchy by using the web portal. In the following, with reference to FIGS. 10 to 16, a display example of content to be released will be described. Specifically, a web portal for PC, a web portal for tablet terminal, and a web portal for portable information terminal will be described with reference to FIG. 10 and FIG. 11, FIG. 12 and FIG. 13, and FIG. 14 to FIG. 16, respectively.

### [Top Page of Web Portal for PC]

FIG. 10 is a diagram showing an example of a top page 301 of a web portal for PC.

In the case where the user terminal 42 is a PC, the user terminal 42 accesses a web portal for PC, and thus the top page 301 of a web portal for PC shown in FIG. 10 is displayed on a display unit thereof.

On the top page 301 of a web portal for PC, a hierarchy display area 321, a search request area 322, and a content-to-be-delivered display area 323 are disposed.

In the hierarchy display area 321, as a folder at the first hierarchical level that is the highest hierarchical level, a folder 331 in which “electrical engineering department” is registered as metadata-for-folders is displayed. Moreover, at a lower hierarchical level than the folder 331 at the first hierarchical level, a folder 331-1 at the second hierarchical level in which “information process II” is registered as metadata-for-folders is created.

In FIG. 10, the folder 331-1 is selected by the user to be in a selected status (highlight display). Therefore, in the content-to-be-delivered display area 323, pieces of information that represent pieces of content registered in the folder 331-1 are displayed.

In the content-to-be-delivered display area 323, pieces of information that represent pieces of content registered in the folder 331-1 are displayed. Specifically, in the content-to-be-delivered display area 323, out of pieces of information that represent contents 341-1 to 341-N (N is an arbitrary integer value of 1 or more), pieces of information that represent the contents 341-1 to 341-4 are displayed. It should be noted that the contents 341-1 to 341-N are collectively referred to as a content 341 if there is no need to distinguish the contents 341-1 to 341-N from each other.

In the search request area 322, in order that the user may search for content to be delivered, an input box to which metadata-for-content (tag) is input as a search key word, a button or the like to set a search condition or a display mode for the search result, and the like are disposed. In the case where content to be delivered is searched for based on the input information to the search request area 322, in the content-to-be-delivered display area 323, information that represents the searched content to be delivered is displayed.

As the information that represents the content 341, preview display, a content name, explanation, metadata, and the like, are displayed. As the preview display, data on the content 341 is converted to be suitable for the display mode of a PC, and then the content 341 is displayed.

### [Detailed Page of Web Portal for PC]

If any one of a plurality of pieces of content 341 displayed in the content-to-be-delivered display area 323 is selected, a detailed page showing details of the selected content 341 is displayed, as shown in FIG. 11.

FIG. 11 is a diagram showing an example of a detailed page 351 of a web portal for PC.

On the detailed page 351 of the web portal for PC, a content detail display area 361 and a related content display area 362 are disposed.

In the content detail display area 361, out of pieces of information that represent the plurality of pieces of content 341 displayed in the content-to-be-delivered display area 323 shown in FIG. 10, information that represents any one of selected content 341 are displayed.

The content detail display area 361 includes a preview display area 371, a metadata display area 372, a chapter display area 373, and a comment display area 374.

In the preview display area 371, the selected content 341 is previewed. It should be noted that on the lower side of the preview display area 371, a release time and date, the number of views, the number of evaluators, the number of related content of the selected content 341 are displayed. As the release time and date, a time and date when the content 341 is released to a web portal for PC. The number of views is displayed as a number at the side of an eye mark, and indicates the number of times that the content 341 is browsed. The number of evaluators is displayed as a number at the side of a star mark, and indicates the number of users who have evaluated the content 341. The number of related content is displayed as a number at the side of a double-rings mark, and indicates the number of content that relates to the content 341. Specifically, the number of content other than the selected content 341, which is registered in the folder in which the content 341 is registered, and content that is registered in a folder at a lower hierarchical level than the content 341 is displayed. In the case of FIG. 11, as the release time and date, the number of views, the number of evaluators, and the number of related content, “2011/08/31 18:00”, “9999”, “9999”, and “99” are displayed, respectively.

If a tab displayed as “metadata” is selected, in an area at the lower side of the tab, the metadata display area 372 is displayed. In the metadata display area 372, metadata associated with the selected content 341 is displayed. Specifically, as shown in FIG. 11, the metadata associated with the selected content 341 includes a category, a tag, explanation, and the like. As the category, metadata-for-folders, which is associated with the folder in which the content 341 is registered and a folder at a higher hierarchical level than that and then automatically registered for the content 341 as metadata-for-content, is displayed. As the tag, a tag for folders registered by the administrator or metadata-for-content to be a tag is displayed. As the explanation, an explanation for the content 341 registered by the administrator is displayed. In the case of FIG. 11, “electrical engineering department>information process II”, “tag 1, tag2, tag3”, and “This content . . . ” are displayed as the category, the tag, and the explanation, respectively.

If a tab displayed as “chapter” is selected, in an area at the lower side of the tab, the chapter display area 373 is displayed. In the chapter display area 373, the content 341 is displayed for each chapter.

If a tab displayed as “comment” is selected, in an area at the lower side of the tab, the comment display area 374 is displayed. In the comment display area 374, the user can write a comment on the content 341. Moreover, in the comment display area 374, another user's comment on the content 341 is displayed.

In the related content display area 362, contents 381-1 to 381-N related to the content 341 displayed in the content detail display area 361 are displayed. In the case of FIG. 11, out of pieces of content stored in the content management/delivery apparatus 41, the contents 381-1 to 381-N exist as other content registered in the same folder as that of the content 341 and a folder at a lower hierarchical level than that. It should be noted that since the number of related content is “99”, which is displayed at the lower side of the preview display area 371, N equals 99. In the related content display area 362, out of pieces of information that represent the 99 pieces of content, pieces of information that represent the contents 381-1 to 381-5 are displayed.

### [Top Page of Web Portal for Tablet Terminal]

FIG. 12 is a diagram showing an example of a top page 401 of a web portal for tablet terminal.

In the case where the user terminal 42 is a tablet terminal, the user terminal 42 accesses a web portal for tablet terminal, and thus the top page 401 of a web portal for tablet terminal shown in FIG. 12 is displayed on a display unit thereof.

On the top page 401 of a web portal for tablet terminal, a content-to-be-delivered display area 421 and content detail display area 422 are disposed. Moreover, at the lower side of the top page 401 of a web portal for tablet terminal, a content list display button 471 and a favorites setting button 472 are disposed.

In the case of FIG. 12, the assumption is made that the content list display button 471 has been pressed. Therefore, in the content-to-be-delivered display area 421, a list of contents 431-1 to 431-N (N is an arbitrary integer value of 1 or more) that are released to a web portal for tablet terminal is displayed. In the case of FIG. 12, in the content-to-be-delivered display area 421, pieces of information that represent the content 431-1 to 431-9, out of the contents 431-1 to 431-N, are displayed. It should be noted that in the following, the contents 431-1 to 431-N are collectively referred to as a content 431 if there is no need to distinguish the contents 431-1 to 431-N from each other.

As the information that represents the content 431, preview display, a content name, the number of views, the number of evaluators, the number of related content are displayed. As the preview display, data of the content 431 is converted to be suitable for the display mode of the tablet terminal, and then the content 431 is displayed.

In the content detail display area 422, information that represents any one selected content 431, out of a plurality of pieces of content 431 shown in the content-to-be-delivered display area 421, is displayed. In the case of FIG. 12, the assumption is made that the content 431-1 is selected.

The content detail display area 422 includes a preview display area 451, a metadata display button 452, a chapter display button 453, a related content display button 454, and a comment display button 455.

In the preview display area 451, the selected content 431-1 is previewed. It should be noted that by selecting a button displayed at the right side of the preview display area 451, the administrator can evaluate the content 431-1, add the content to favorites, share the URL of the released content 431-1 with others, and download the content 431-1.

If the metadata display button 452 is selected, in an area at the lower side of the metadata display button 452, metadata associated with the selected content 431-1 is displayed. It should be noted that since the metadata to be displayed is the same as that displayed in the metadata display area 372 shown in FIG. 11, the description thereof will be omitted.

If the chapter display button 453 is selected, in an area at the lower side of the chapter display button 453, the content 431-1 is displayed for each chapter.

If the related content display button 454 is selected, in an area at the lower side of the related content display button 454, as shown in FIG. 13, contents 491-1 to 491-N related to the content 431-1 are displayed.

### [Display Example of Related Content]

FIG. 13 is a diagram for explaining a display example of related content.

As shown in FIG. 13, if the related content display button 454 is selected, in the area at the lower side of the related content display button 454, the contents 491-1 to 491-N related to the content 431-1 are displayed. In the case of FIG. 13, out of pieces of content stored in the content management/delivery apparatus 41, the contents 491-1 to 491-N exist as other content registered in the same folder as that of the content 431-1 and a folder at a lower hierarchical level than that. It should be noted that since the number of related content, which is displayed as information that represents the content 431-1 in the content-to-be-delivered display area 421, is “10”, N equals 10. In an area at the lower side of the related content display button 454, pieces of information that represent the contents 491-1 to 491-3, out of the 10 pieces of content, are displayed.

Turning back to FIG. 12, if the comment display button 455 is selected, in an area at the lower side of the comment display button 455, the user can write a comment on the content 431-1. Moreover, in the area at the lower side of the comment display button 455, another user's comment on the content 431-1 is displayed.

By pressing the favorites setting button 472, the user can add any one selected content 431, out of the plurality of pieces of content 431 displayed in the content-to-be-delivered display area 421, to favorites.

It should be noted that in the case where the user terminal 42 is a tablet terminal, the user can perform an operation on the web portal for tablet terminal by touching a touch panel that is laminated on the display unit in the tablet terminal with a finger or moving the finger closer to the touch panel.

### [Top Page of Web Portal for Portable Information Terminal]

FIG. 14 is a diagram showing an example of a top page 511 of a web portal for portable information terminal.

In the case where the user terminal 42 is an information terminal, the user terminal 42 accesses a web portal for portable information terminal, and thus the top page 511 of a web portal for portable information terminal shown in FIG. 14 is displayed on a display unit thereof.

At the lower side of the top page 511 of a web portal for portable information terminal, a content list display button 531 and a favorites setting button 532 are disposed. In the case of FIG. 14, the assumption is made that the content list display button 531 has been pressed.

Therefore, on the top page 511 of a web portal for portable information terminal, contents 521-1 to 521-N (N is an arbitrary integer value of 1 or more) that are released to the web portal for portable information terminal are displayed. In the case of FIG. 14, on the top page 511, pieces of information that represent the contents 521-1 to 521-5, out of the contents 521-1 to 521-N, are displayed. It should be noted that the contents 521-1 to 521-N are collectively referred to as a content 521 if there is no need to distinguish the contents 521-1 to 521-N from each other.

As the information that represents the contents 521, a preview button to preview the content 521, a content name, a release time and date, the number of views, the number of evaluators, and the number of related content are displayed. In the portable information terminal, preview display of the content 521 is not performed and a preview button is displayed so as not to increase the amount of data. Specifically, only if the user presses the preview button and an instruction to perform preview display is made, the content 521 is previewed.

By pressing the favorites setting button 532, the user can add any one selected content 521, out of a plurality of pieces of content 521 displayed on the top page 511 of a web portal for portable information terminal, to favorites.

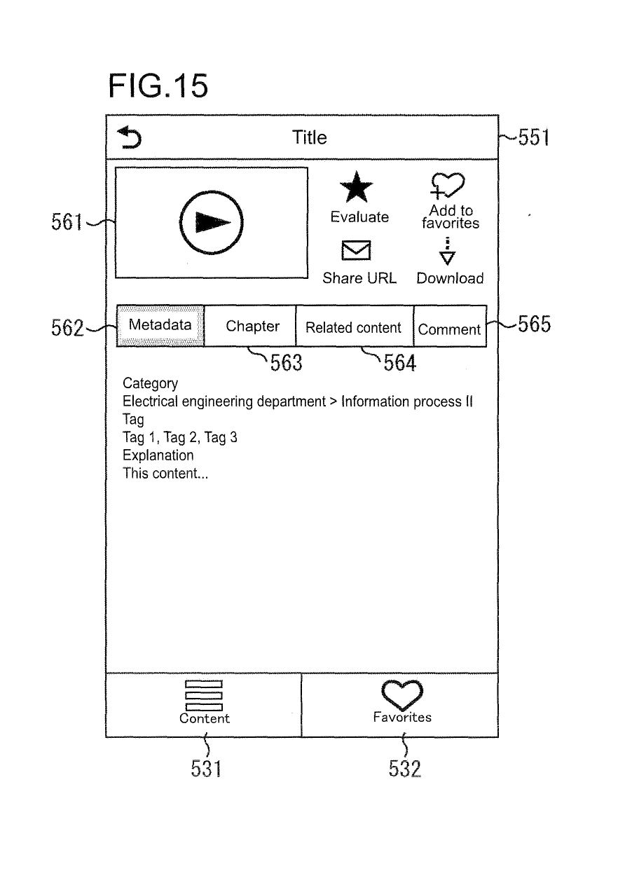

If any one of the plurality of pieces of content 521 displayed on the top page 511 of a web portal for portable information terminal is selected, as shown in FIG. 15, information that represents the selected content 521, is displayed.

### [Detailed Page of Web Portal for Portable Information Terminal]

FIG. 15 is a diagram showing an example of a detailed page 551 of a web portal for portable information terminal.

On the detailed page 551 of a web portal for portable information terminal, information that represents any one selected content 521, out of a plurality of pieces of content 521 displayed on the top page 511 shown in FIG. 14, is displayed. In this case, the assumption is made that the content 521-1 is selected.

The detailed page 551 includes a preview display area 561, a metadata display button 562, a chapter display button 563, a related content display button 564, and a comment display button 565.

In the preview display area 561, if the preview button is pressed, the selected content 521-1 is previewed. It should be noted that by selecting a button displayed at the right side of the preview display area 561, the administrator can evaluate the content 521-1, add the content to favorites, share the URL of the released content 521-1 with others, and download the content 521-1.

If the metadata display button 562 is selected, in an area at the lower side of the metadata display button 562, metadata associated with the selected content 521-1 is displayed. It should be noted that since the metadata to be displayed is the same as that displayed in the metadata display area 372 shown in FIG. 11, the description thereof will be omitted.

If the chapter display button 563 is selected, in an area at the lower side of the chapter display button 563, the content 521-1 is displayed for each chapter.

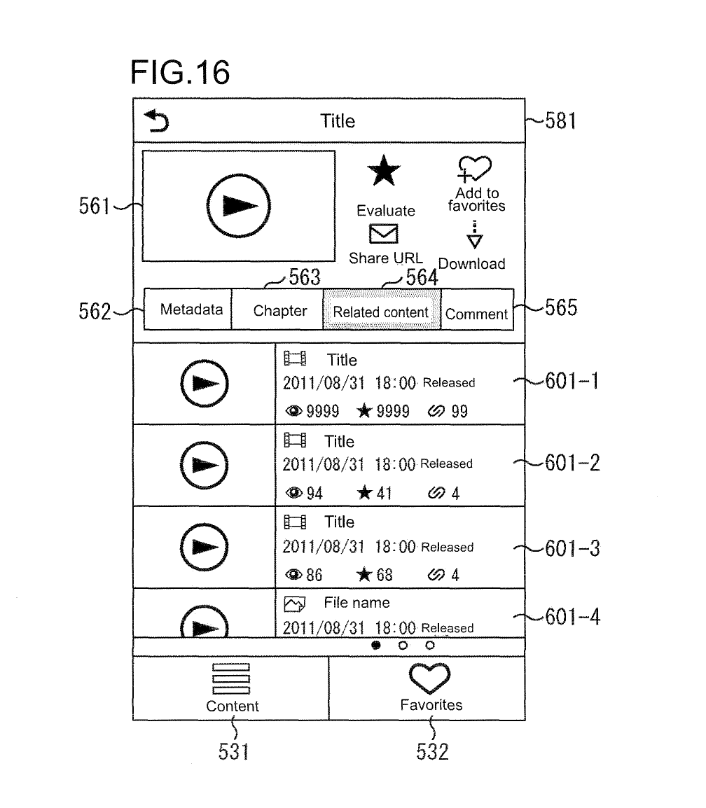

If the related content display button 564 is selected, in an area at the lower side of the related content display button 564, as shown in FIG. 16, contents 601-1 to 601-N related to the content 521-1 are displayed.

### [Related Content Display Page of Web Portal for Portable Information Terminal]

FIG. 16 is a diagram showing an example of a related content display page 581 in the web portal for portable information terminal.

On the related content display page 581 in a web portal for portable information terminal, the contents 601-1 to 601-N related to the content 521-1 are displayed. In the case of FIG. 16, out of pieces of content stored in the content management/delivery apparatus 41, the contents 601-1 to 601-N exist as other content registered in the same folder as that of the content 521-1 and a folder at a lower hierarchical level than that. It should be noted that since the number of related content, which is displayed as information that represents the content 521-1 on the top page 511 shown in FIG. 14, is “99”, N equals 99. In an area at the lower side of the related content display button 564, pieces of information that represent the contents 601-1 to 601-4, out of the 99 pieces of content, are displayed.

Turning back to FIG. 15, if the comment display button 565 is selected, in an area at the lower side of the comment display button 565, the user can write a comment on the content 521-1. Moreover, in the area at the lower side of the comment display button 565, another user's comment on the content 521-1 is displayed.

It should be noted that in the case where the user terminal 42 is a portable information terminal, the user can perform an operation on the web portal for portable information terminal by touching a touch panel laminated on the display unit in the portable information terminal with a finger or moving the finger closer to the touch panel.

As described above, since the content management/delivery apparatus 41 associates pieces of content with each other, in a web portal for the user terminal 42, in the case where predetermined content is selected, content related to the predetermined content can be displayed.

In a content management/delivery system in related art, in order to associate a plurality of pieces of relevant content with each other, the administrator associates the content with each other by using a dedicated UI screen or the like in some cases, which may cause the administrator to perform a complicated operation. However, according to the content management/delivery apparatus 41, it is possible to associate a plurality of pieces of content with each other by a simple operation.

### [Application of Present Disclosure to Program]

The series of processes described above can be performed by hardware and software. In the case where the series of processes is performed by software, a program constituting the software is installed into a computer. Here, example of the computer includes a computer incorporated in dedicated hardware and a general-purpose personal computer that can execute various functions by installing various programs thereon.

For example, in the content management/delivery apparatus 41 shown in FIG. 3 that is an example of the computer, the CPU 51 loads, for example, a program stored in the storage 58 into the RAM 53 via the input/output interface 55 and the bus 54 and then executes the program, thereby performing the series of processes described above.

The program performed by the computer can be stored in the removable medium 61 serving as a package media or the like to be provided. Moreover, the program can be provided via a wired or wireless transmission medium such as a local area network, the Internet, and digital satellite broadcasting.

In the computer, the program can be installed in the storage 58 via the input/output interface 55 by mounting the removable medium 61 to the drive 60. Moreover, the program can be received by the communication unit 59 and installed in the storage 58 via a wired or wireless transmission medium. In addition, the program can be installed in the ROM 52 or the storage 58 in advance.

It should be noted that the program executed by the computer may be a program that is processed in time series in the order described in this specification or a program that is processed in parallel, or at necessary timing, e.g., when being called.

The embodiments of the present disclosure are not limited to the above-mentioned embodiments and various modifications can be made without departing from the gist of the present disclosure.

For example, the present disclosure may take a configuration of cloud computing in which a function is performed via a network by a plurality of apparatuses sharing processes.

Moreover, each Step described in the flowchart can be performed by one apparatus or can be performed by a plurality of apparatuses sharing the processes.

Furthermore, in the case where one Step includes a plurality of processes, the plurality of processes can be performed by one apparatus or can be performed by a plurality of apparatuses by sharing the process.

It should be noted that the present disclosure may also take the following configurations.

(1) An information processing apparatus, including:

a folder creation unit configured to create a folder at a predetermined hierarchical level in a predetermined hierarchy of folders; and

a content registration unit configured to store content in the folder and associate the content with different content, so that the content is registered for the folder, the folder being created by the folder creation unit, the different content being stored in the same folder as the content.

(2) The information processing apparatus according to (1), further including:

metadata-for-folders registration unit configured to associate the folder with metadata-for-folders and register, for the folder, the metadata-for-folders, the folder being created by the folder creation unit; and

metadata-for-content registration unit configured to associate the content with the metadata-for-folders and register, for the folder, the metadata-for-folders as metadata-for-content, the metadata-for-folders being associated with and registered for the folder by the metadata-for-folders registration unit, the content being stored in the folder by the content registration unit.

(3) The information processing apparatus according to (1) or (2), in which

the metadata-for-content registration unit is configured to register, as the metadata-for-content, not only the metadata-for-folders registered for the folder but also different metadata-for-folders registered for a different folder, the folder storing the content, the different folder being created at a higher hierarchical level than the folder.

(4) The information processing apparatus according to any one of (1) to (3), further including

a content delivery unit configured to release the content to a web portal for content delivery, the content being registered by the content registration unit.

(5) The information processing apparatus according to any one of (1) to (4), in which

the content delivery unit is configured to release a plurality of pieces of content to the web portal as related content, the plurality of pieces of content being associated with and stored in the same folder.

The present disclosure can be applied to an information processing apparatus that delivers content.

The present disclosure contains subject matter related to that disclosed in Japanese Priority Patent Application JP 2012-035994 filed in the Japan Patent Office on Feb. 22, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a folder creation unit configured to create a folder at a predetermined hierarchical level in a predetermined hierarchy of folders; and
a content registration unit configured to store content in the folder and associate the content with different content, so that the content is registered for the folder, the folder being created by the folder creation unit, the different content being stored in the same folder as the content.

2. The information processing apparatus according to claim 1, further comprising:
metadata-for-folders registration unit configured to associate the folder with metadata-for-folders and register, for the folder, the metadata-for-folders, the folder being created by the folder creation unit; and
metadata-for-content registration unit configured to associate the content with the metadata-for-folders and register, for the folder, the metadata-for-folders as metadata-for-content, the metadata-for-folders being associated with and registered for the folder by the metadata-for-folders registration unit, the content being stored in the folder by the content registration unit.

3. The information processing apparatus according to claim 2, wherein
the metadata-for-content registration unit is configured to register, as the metadata-for-content, not only the metadata-for-folders registered for the folder but also different metadata-for-folders registered for a different folder, the folder storing the content, the different folder being created at a higher hierarchical level than the folder.

4. The information processing apparatus according claim 1, further comprising
a content delivery unit configured to release the content to a web portal for content delivery, the content being registered by the content registration unit.

5. The information processing apparatus according to claim 4, wherein
the content delivery unit is configured to release a plurality of pieces of content to the web portal as related content, the plurality of pieces of content being associated with and stored in the same folder.

6. An information processing method for an information processing apparatus, comprising: by the information processing apparatus,
creating a folder at a predetermined hierarchical level in a predetermined hierarchy of folders;
storing content in the created folder; and
associating the content with different content, so that the content is registered for the folder, the different content being stored in the same folder as the content.

7. A program that causes a computer to function as:
a folder creation unit configured to create a folder at a predetermined hierarchical level in a predetermined hierarchy of folders; and
a content registration unit configured to store content in the folder and associate the content with different content, so that the content is registered for the folder, the folder being created by the folder creation unit, the different content being stored in the same folder as the content.
